(19) United States
(12) Patent Application Publication
(10) Pub. No.: US 2025/0206644 A1
(43) Pub. Date: Jun. 26, 2025

(54) METHOD FOR NITROGEN REMOVAL WASTEWATER

(71) Applicant: NANJING UNIVERSITY, Nanjing (CN)

(72) Inventors: Aimin LI, Nanjing (CN); Minhui CAI, Nanjing (CN); Yuan LIU, Nanjing (CN); Qing ZHOU, Nanjing (CN); Wentao LI, Nanjing (CN)

(21) Appl. No.: 18/956,593

(22) Filed: Nov. 22, 2024

(30) Foreign Application Priority Data
Dec. 22, 2023 (CN) 202311787075.4

(51) Int. Cl. C02F 3/30; C02F 101/16

(52) U.S. Cl. CPC C02F 3/305; C02F 2101/16; C02F 2209/06; C02F 2209/08; C02F 2305/026; C02F 2305/14

(57) ABSTRACT

The present invention discloses a method for nitrogen removal of wastewater, which achieves the perfect combination of COD removal (Fenton oxidation) and nitrogen removal (Feammox) of wastewater, thereby avoiding the waste of reagents in traditional Fenton oxidation treatment of wastewater.

### TECHNICAL FIELD

The present invention belongs to the field of wastewater treatment in environmental engineering, and specifically, relates to a method for nitrogen removal of wastewater.

### BACKGROUND

The chemical industry is an indispensable and important part of the national economy. The diversity of chemical products determines that chemical wastewater has characteristics of large water volume, high toxicity and complex water quality, which are often accompanied by high concentrations of COD and ammonia nitrogen.

In fact, chemical wastewater is generally treated using the Fenton process, which generates hydroxyl radicals through the reaction of ferrous ions with hydrogen peroxide, destroys the structure of organic matters, and ultimately oxidizes and decomposes organic matters to reduce the COD content of water body. The main process flow of the Fenton process includes acidity adjustment (the pH value is preferably controlled at 3.0-4.0), oxidation reaction, neutralization, solid-liquid separation, etc. In addition, the vast majority of wastewater treatment projects are undergoing upgrading and reconstruction since the secondary treatment cannot reduce nitrogen in wastewater to the effluent standard. These projects focus on improving the nitrogen removal process in wastewater treatment. The nitrogen removal technology includes chemical and biological methods. Because of the secondary pollution and high cost of chemical methods, biological nitrogen removal technology is generally used.

The biological treatment for nitrogen removal of wastewater mainly relies on specialized bacteria to realize the transformation of nitrogen forms. Firstly, nitrogen-containing organic compounds are decomposed and converted into ammonia nitrogen NH₄⁺ or NH₃ under the action of microorganisms, this process is called the “ammonification reaction”; then nitrifying bacteria convert the ammonia nitrogen into nitrate, this process is called the “nitrification reaction”; and then denitrifying bacteria convert the nitrate into nitrogen gas, and this process is called the “denitrification reaction”. Finally, the nitrogen-containing organic compounds are converted into nitrogen gas and removed from wastewater.

Based on the above description, the existing nitrogen removal treatment process for chemical wastewater mainly consists of two segments: aerobic and anoxic segments. High concentration of ammonia nitrogen is first converted into nitrate in the aerobic segment, and then the nitrate flows into the anoxic segment for denitrification and thus is converted into nitrogen gas, thereby achieving the removal of ammonia nitrogen. However, this traditional nitrification-denitrification process requires a lot of aeration and huge energy consumption.

Therefore, it is of great significance to develop a low-energy, high-efficiency, and stable method for detoxification and nitrogen removal of wastewater.

### SUMMARY OF THE INVENTION

### 1. Problems to be Solved

The present invention provides a method for nitrogen removal of wastewater to address the energy consumption and other issues of existing wastewater nitrogen removal processes.

### 2. Technical Solutions

In order to solve the above problems, the technical solutions adopted by the present invention are as follows.

The present invention provides a method for nitrogen removal of wastewater, which comprises:
S1. performing Fenton oxidation treatment on wastewater;
S2. performing neutralization and precipitation treatment on the effluent after the Fenton oxidation treatment, and controlling the pH value between 4-6;
S3. directly subjecting the effluent after the neutralization and precipitation treatment to Feammox treatment in an anaerobic environment;
S4. performing anoxic treatment on the effluent after the Feammox treatment;
wherein in the S3, no extra Fe (III) source is added.

As described herein, it is very important to “control the pH value between 4-6” in S2. This can transform the Fe (III) contained in Fenton iron sludge, which should have been treated as hazardous solid waste after the Fenton oxidation treatment, into a dissolved state. Dissolved Fe (III) enters the process of S3 and plays the role as an iron source for Feammox treatment, thereby avoiding the introduction of additional Fe (III). Based on this, it is more preferable to “control the pH value between 4.5-5.5”.

In addition, it should be noted that the above-mentioned technical solution achieves the perfect combination of COD removal (Fenton oxidation) and nitrogen removal (Feammox) of wastewater, thereby avoiding the consumption of reagents after traditional Fenton oxidation treatment of wastewater. Specifically, the technical specifications for traditional Fenton oxidation wastewater treatment engineering specify that (after the Fenton oxidation reaction), the pH of Fenton effluent needs to be adjusted to 7-9 in the neutralization unit (because the pH value is generally controlled below 4 during Fenton oxidation, this inevitably leads to the consumption of a large amount of alkali in the neutralization unit) to form precipitate.

It should be further noted that, based on the mass volume concentration, when the content of ammonia nitrogen in the wastewater to be treated does not exceed half of the COD content, it can ensure the optimal nitrogen removal effect for the wastewater on the premise of achieving effective COD removal.

According to any embodiment of the objective of the present invention, in the S1, before the Fenton oxidation treatment for the wastewater, an acidity adjustment treatment step is included, and the pH value of the wastewater after the acidity adjustment treatment is 3-4.

According to any embodiment of the objective of the present invention, in the S1, before the Fenton oxidation treatment for the wastewater, the content of suspended solids in the wastewater should be controlled to be less than 200 mg/L.

According to any embodiment of the objective of the present invention, based on the mass volume concentration of COD contained in the wastewater,
the ratio of the added amount of hydrogen peroxide to the content of the COD is (1-2):1, and
the ratio of the added amount of hydrogen peroxide to the added amount of ferrous ions is (1-10):1.

According to any embodiment of the objective of the present invention, in the S1, ferrous ions are first added to the wastewater, which is followed by the addition of hydrogen peroxide at intervals of 5-30 minutes for Fenton oxidation treatment, and the Fenton oxidation treatment is performed for a duration of 2-8 hours.

According to any embodiment of the objective of the present invention, in the S1, spray treatment or adding defoamers can be carried out while performing the Fenton oxidation treatment so as to remove the floating foam on the surface of the wastewater.

According to any embodiment of the objective of the present invention, in the S2, the method further comprises adding a flocculant with a dosage set at 100-205 mg/L.

Preferably, the flocculant is composed of polyaluminum chloride and polyacrylamide, wherein the dosage of polyaluminum chloride is 100-200 mg/L, and the dosage of polyacrylamide is 3-5 mg/L.

According to any embodiment of the objective of the present invention, in the S2, the hydraulic retention time for the neutralization and precipitation treatment is 2-4 hours.

According to any embodiment of the objective of the present invention, in the S3, the method comprises a start-up stage.

According to any embodiment of the objective of the present invention, in the S3, the dissolved oxygen is maintained below 0.2 mg/L during the Feammox treatment.

According to any embodiment of the objective of the present invention, in the S3, the hydraulic retention time for the Feammox treatment is 4-8 hours.

According to any embodiment of the objective of the present invention, in the S3, the temperature during the Feammox treatment is between 20-35° C.

According to any embodiment of the objective of the present invention, in the S4, the dissolved oxygen is maintained at 0.2-0.4 mg/L during the anoxic treatment.

According to any embodiment of the objective of the present invention, in the S4, the hydraulic retention time for the anoxic treatment is 4-8 hours.

According to any embodiment of the objective of the present invention, the method further comprises S5. treating the sludge precipitate after the anoxic treatment with acid.

According to any embodiment of the objective of the present invention, in the S5, the supernatant obtained after the treatment is recycled to S1.

### Beneficial Effects

(1) In fact, chemical wastewater is generally treated with the Fenton process to reduce the COD content of the water body, and the main process flow of the Fenton process is as shown in FIG. 2, including acidity adjustment, oxidation reaction, neutralization, solid-liquid separation or the like. Moreover, according to the “Technical Specification for Fenton Oxidation Wastewater Treatment Engineering” in the “National Environmental Protection Standards of the People's Republic of China” (HJ 1095-2020), it is necessary to adjust the pH of Fenton effluent to 7-9 in the neutralization unit to form precipitate in order to meet the subsequent effluent requirements. This process requires the addition of a large amount of precipitating reagents, which increases operating costs. Based on this, the method for nitrogen removal of wastewater provided according to the present invention achieves the perfect combination of COD removal (Fenton oxidation) and nitrogen removal (Feammox) of wastewater, thereby avoiding the consumption of reagents after traditional Fenton oxidation treatment of wastewater.

In addition, the method for nitrogen removal of wastewater provided according to the present invention transforms the Fe (III) contained in Fenton iron sludge, which should have been treated as hazardous solid waste after Fenton oxidation treatment, into a dissolved state so that the Fe (III) follows the water body to be treated into the process of S3 to be used as an iron source for Feammox treatment, thereby avoiding the addition of additional Fe (III);
and as compared to the traditional nitrification-denitrification nitrogen removal processes, there is no need for further aeration.

In summary, the method for nitrogen removal of wastewater provided according to the present invention saves a significant amount of energy consumption and greatly reduces operating costs.

(2) According to the method for nitrogen removal of wastewater provided according to the present invention, the added dissolved state iron can facilitate the process of iron reduction and oxidation of organic matters, and it has a good degradation effect on aromatic organic matters, which is beneficial for nitrogen removal and detoxification.

(3) The method for nitrogen removal of wastewater provided according to the present invention can be directly upgraded in situ based on the existing Fenton and biological segment processes of chemical wastewater treatment plants, with low reconstruction costs and extremely strong applicability.

(4) The method for nitrogen removal of wastewater provided according to the present invention can re-dissolve out the Fe (II) reduced during the Feammox treatment with a small amount of added acid and reapply it to the Fenton process, thereby reducing the addition of iron salts and achieving clean regeneration.

### BRIEF DESCRIPTION OF THE DRAWINGS

FIG. 1 is a flowchart schematic diagram of the process for nitrogen removal of wastewater provided in Example 1 of the present invention.

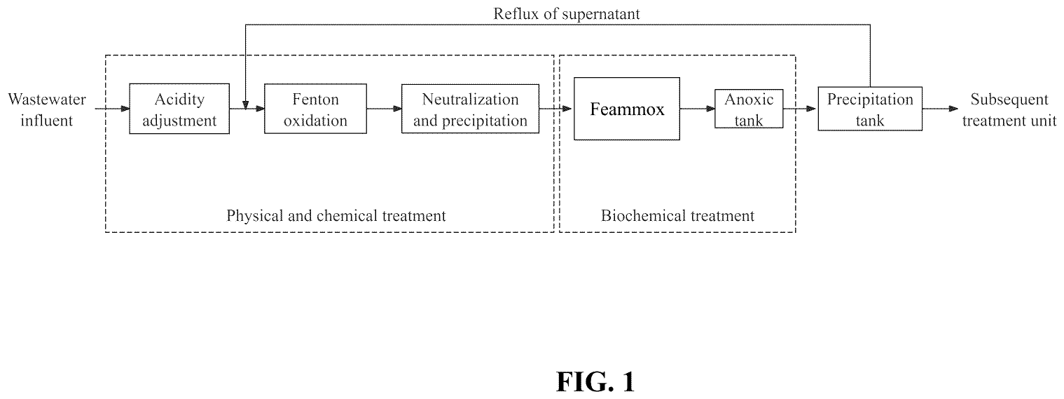

FIG. 2 is a schematic diagram of a process flow of a traditional Fenton oxidation wastewater treatment engineering.

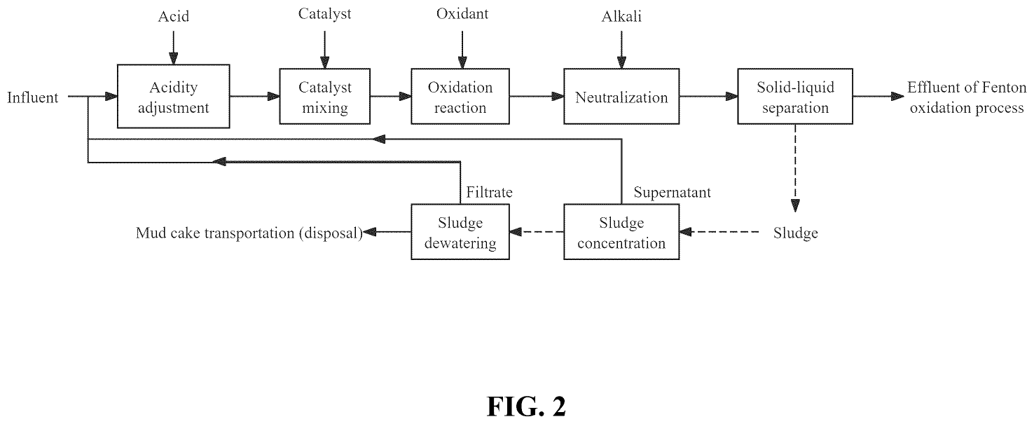

### DETAILED DESCRIPTION OF THE INVENTION

The present disclosure can be appreciated more easily from the following description by referencing and combining with examples, and all the examples constitute a part of the present disclosure. It should be appreciated that, the present disclosure is not limited to the specific products, methods, conditions, or parameters described and/or illustrated herein. Furthermore, the terms used herein are only intended to describe specific embodiments by way of example and are not intended to be limiting, unless otherwise specified.

It should also be appreciated that for clarity, certain features of the present disclosure may be described herein in the context of individual embodiments, but may also be provided in combination with each other in a single embodiment. That is, unless it is clearly incompatible or specifically excluded, each individual embodiment is considered to be combinable with any other embodiments, and the combination is considered to represent another different embodiment. On the contrary, for the sake of simplicity, various features of the present disclosure described in the context of a single embodiment may also be provided individually or in any sub-combination. Finally, although specific embodiments may be described as parts of a series of steps or parts of more general structures, each step or substructure itself may also be considered as an independent embodiment.

Unless otherwise specified, it should be appreciated that, each individual element in the list and each combination of individual elements in the list will be interpreted as different embodiments. For example, the list of embodiments represented as “A, B, or C” should be interpreted as including embodiments “A”, “B”, “C”, “A or B”, “A or C”, “B or C”, or “A, B, or C”.

In the present disclosure, the singular forms of articles “a/an”, “one”, and “the” also include corresponding plural referents, and references to specific numerical values include at least that specific value, unless otherwise explicitly stated in the context. Therefore, for example, the reference to “substance” is the reference to at least one of this substance and its equivalents.

Terms including ordinal numbers such as “first” and “second” may be used to explain various components or fluids, but these components and fluids are not limited by these terms. Therefore, without departing from the teachings of the present disclosure, these terms are only used to distinguish this component/fluid from another component/fluid.

When describing an item using binding terms such as “. . . and/or . . . ”, the description should be appreciated as including any one of the associated items listed, as well as all combinations of one or more of the items.

Typically, the use of the term “about” refers to an approximate value that can vary based on the expected characteristics obtained through the disclosed subject matter, and will be interpreted in a context dependent manner based on functionality. Therefore, those of ordinary skill in the art will be able to explain certain degrees of differences on a case-by-case basis. In some cases, the number of important digits used to express a specific value may be a representative technique for determining the differences allowed by the term “about”. In other cases, gradients in a series of values may be used to determine the range of differences allowed by the term “about”. Further, all ranges disclosed in the present disclosure are inclusive and combinable, and references to values within a range include each value within the range.

Unless otherwise defined, all technical and scientific terms used herein have the same meanings as those commonly understood by those skilled in the art belonging to the present invention. The term and/or used herein include any and all combinations of one or more associated items listed.

Embodiments described below for which specific conditions are not specified shall be conducted according to the conventional conditions or conditions recommended by the manufacturers. The used reagents or instruments for which the manufacturers are not specified are conventional products that can be obtained through commercial purchase.

The present invention will be further illustrated hereinafter with reference to specific embodiments, but the embodiments do not limit the present invention in any form. Unless otherwise specified, the reagents, methods, and equipment used in the present invention are conventional reagents, methods, and equipment in the art. The essential features and significant effects of the present invention can be reflected in the following embodiments, which are a part but not all of the embodiments of the present invention. Therefore, these embodiments do not limit the present invention in any way, and some non-essential improvements and adjustments made by those skilled in the art based on the content of the present invention are all within the scope claimed in the present invention.

### Example 1

In this example, a wastewater nitrogen removal process using Fenton combined biological Feammox is provided, with the specific steps as follows.

S1. performing acidity adjustment treatment on wastewater

The pH of the influent water was maintained at an acidic condition of 3.2, and if the pH of the influent water does not meet the requirements, then an acidity regulating tank will be set up in advance, and 98% concentrated sulfuric acid or 50% dilute sulfuric acid are added to adjust the pH value of the wastewater. Mechanical stirring was adopted, and the mixing time was 5 minutes.

The acid solution was added using a corrosion-resistant metering pump, and the dosage was automatically adjusted through an online pH meter.

S2: performing Fenton reaction treatment on the acidity adjusted wastewater in a Fenton oxidation reaction tank;

The Fenton oxidation treatment involves first adding ferrous sulfate (pre-configured in the solution tank with a mass percentage concentration of 20%), waiting for 15 minutes, and then adding 30 wt % hydrogen peroxide. The addition was conducted at a ratio of hydrogen peroxide concentration (mg/L) to COD (mg/L) of 2:1, and a ratio of hydrogen peroxide concentration (mg/L) to ferrous ion concentration (mg/L) of 3:1.

The hydraulic retention time in the Fenton oxidation reaction tank was 2 hours, and during this period, if a large amount of floating foam appears, then water spray or defoaming spray may be adopted.

S3: performing neutralization and precipitation treatment on the effluent after the Fenton reaction treatment in a neutralization and precipitation tank

The neutralization and precipitation tank needs to be adjusted to pH of 4.5 by adding alkaline solution, which is a 10% sodium hydroxide solution.

At the same time, polyaluminum chloride and polyacrylamide were added at dosages set to 120 mg/L and 3 mg/L.

The hydraulic retention time in the neutralization and precipitation tank was set to be 3 hours.

S4: performing Feammox treatment on the effluent after the neutralization and precipitation treatment in the Feammox reaction tank

During the start-up stage (which may be carried out in advance), anaerobic sludge from the sewage treatment plant (from the sludge concentration tank) was inoculated with a sludge concentration of around 3 g/L MLSS, the temperature was maintained at 30° C. and the pH was maintained at 6.5. The start-up time was 2 weeks, during which the adaptability of the Feammox functional microflora was enhanced by adding ammonium chloride and sodium bicarbonate.

After the start-up is completed, Feammox treatment is carried out on the effluent after the neutralization and precipitation treatment in the Feammox reaction tank. During the treatment, the dissolved oxygen was controlled below 0.2 mg/L, the hydraulic retention time was set at 6 hours, and the temperature was maintained at 30° C.

S5. performing anoxic treatment on the effluent after the Feammox treatment in an anoxic reaction tank

The anoxic treatment was performed in an anoxic reaction tank by adding glucose with a C/N ratio of 2.5 as a carbon source to the effluent after the Feammox treatment. The anoxic treatment can effectively remove a large amount of Feammox products such as nitrite and nitrate in the water by utilizing denitrifying bacteria in the anoxic reaction tank, thereby achieving nitrogen removal.

During the process, the dissolved oxygen in the anoxic reaction tank was controlled at 0.2-0.4 mg/L, and the hydraulic retention time was set to be 4 hours.

S6: performing precipitation treatment on the effluent after the anoxic treatment in the precipitation tank.

A small amount of acid solution was added to the effluent after the anoxic treatment in the precipitation tank to dissolve out the residual divalent iron in the sludge. The effluent flows back to the front end of the Fenton process through a reflux pipe, thereby reducing the use amount of ferrous sulfate and achieving clean regeneration.

98% concentrated sulfuric acid was used as the acid solution at a dosage of 100 mL/t, and the reflux ratio was 50%.

The basic information before and after wastewater treatment is shown in Table 1 below.

TABLE 1
Water body information before and after treatment

| | Before | After | |
|---|---|---|---|
| | treatment | treatment | Removal |
| Items | (mg/L) | (mg/L) | rate |
| COD | 600 | 30 | 95% |
| Ammonia nitrogen | 240 | 5 | 97.9% |

### Example 2

This example was basically the same as Example 1, with the only difference being:
in S3, alkaline solution was added to adjust the pH to 4.0 during the neutralization and precipitation treatment of the effluent after the Fenton reaction treatment in the neutralization and precipitation tank.

### Example 3

This example was basically the same as Example 1, with the only difference being:
in S3, alkaline solution was added to adjust the pH to 5.5 during the neutralization and precipitation treatment of the effluent after the Fenton reaction treatment in the neutralization and precipitation tank.

### Example 4

This example was basically the same as Example 1, with the only difference being:
in S3, alkaline solution was added to adjust the pH to 7.0 during the neutralization and precipitation treatment of the effluent after the Fenton reaction treatment in the neutralization and precipitation tank.

The basic information before and after wastewater treatment is shown in Table 2 below.

TABLE 2
Water body information before and after treatment

| | | Before treatment | After treatment | Removal |
|---|---|---|---|---|
| | Items | (mg/L) | (mg/L) | rate |
| Example 1 | COD | 600 | 30 | 95% |
| | Ammonia | 240 | 5 | 97.9% |
| | nitrogen | | | |
| Example 2 | COD | 600 | 87 | 85.6% |
| | Ammonia | 240 | 47 | 80.4% |
| | nitrogen | | | |
| Example 3 | COD | 600 | 45 | 92.5% |
| | Ammonia | 240 | 11 | 95.3% |
| | nitrogen | | | |
| Example 4 | COD | 600 | 237 | 60.5% |
| | Ammonia | 240 | 186 | 22.7% |
| | nitrogen | | | |

As can be seen from Table 2, the removal rates of both COD and ammonia nitrogen can be more than 80% when the pH is between 4-6, and the best effect is achieved with removal rates of more than 90% when the pH is between 4.5-5.5. When the pH is greater than 6, e.g., the pH is 7, the removal rate of ammonia nitrogen is rapidly decreased.

What are described above are only preferred embodiments of the present invention. It should be noted that for those of ordinary skill in the art, several improvements and variations can be made without departing from the technical principles of the present invention, and these improvements and variations should also be considered within the scope claimed in the present invention.

What is claimed is:

1. A method for nitrogen removal of wastewater, characterized in that, it comprises:
S1. performing Fenton oxidation treatment on wastewater;
S2. performing neutralization and precipitation treatment on the effluent after the Fenton oxidation treatment, and controlling the pH value between 4-6;
S3. directly subjecting the effluent after the neutralization and precipitation treatment to Feammox treatment in an anaerobic environment;
S4. performing anoxic treatment on the effluent after the Feammox treatment;
wherein in the S3, no extra Fe (III) source is added.

2. The method for nitrogen removal of wastewater according to claim 1, characterized in that, it also comprises:
S5. treating a sludge precipitate after the anoxic treatment with acid.

3. The method for nitrogen removal of wastewater according to claim 2, characterized in that, in the S5,
a supernatant obtained after the treatment is recycled to S1.

4. The method for nitrogen removal of wastewater according to claim 1, characterized in that, in the S1,
based on a mass volume concentration of COD contained in the wastewater,
a ratio of an added amount of hydrogen peroxide to a content of the COD is (1-2):1, and
a ratio of an added amount of hydrogen peroxide to an added amount of ferrous ions is (1-10):1.

5. The method for nitrogen removal of wastewater according to claim 4, characterized in that, in the S2,
the method also comprises adding a flocculant, and a dosage of the flocculant is set at 100-205 mg/L.

6. The method for nitrogen removal of wastewater according to claim 5, characterized in that, in the S2,
a hydraulic retention time for the neutralization and precipitation treatment is 2-4 hours.

7. The method for nitrogen removal of wastewater according to claim 1, characterized in that, in the S3,
a dissolved oxygen is maintained below 0.2 mg/L during the Feammox treatment.

8. The method for nitrogen removal of wastewater according to claim 7, characterized in that, in the S3,
a hydraulic retention time for the Feammox treatment is 4-8 hours.

9. The method for nitrogen removal of wastewater according to claim 1, characterized in that, in the S4,
a dissolved oxygen is maintained at 0.2-0.4 mg/L during the anoxic treatment.

10. The method for nitrogen removal of wastewater according to claim 9, characterized in that, in the S4,
a hydraulic retention time for the anoxic treatment is 4-8 hours.
